(19) United States
(12) Patent Application Publication
(10) Pub. No.: US 2002/0130834 A1
(43) Pub. Date: Sep. 19, 2002

(54) System and method for universal control of devices

(75) Inventors: Richard L. Madarasz, Tempe, AZ (US); Kathleen M. Mutch, Tempe, AZ (US)

Correspondence Address: Squire, Sanders & Dempsey L.L.P., Two Renaissance Square, Suite 2700, 40 North Central Avenue, Phoenix, AR, 85004-4498, US

(73) Assignee: Emsquare Research, Inc.

(21) Appl. No.: 09/810,069

(22) Filed: Mar. 16, 2001

(51) Int. Cl. G09G 5/00; G09G 5/08

(52) U.S. Cl. 345/156; 345/158

(57) ABSTRACT

A method and apparatus that gives a human user universal control of electronic devices. The apparatus includes a local display device having a simulation viewer program for simulating controls of the electronic device on a display, where the simulation is generated based on a simulation configuration file associated with each electronic device. The local display device loads the simulation configuration file of a selected electronic device communicating on a communications network and simulates the controls of the electronic device associated with the loaded simulation configuration. The communications network is preferably a wireless network using a Bluetooth communications protocol. When a user selects an identifier on the local display device designating a particular electronic device, the simulation viewer program requests and receives from the electronic device, the simulation configuration file that allows the simulation viewer program to simulation the appearance and functions of the electronic device on the local display device.

### BACKGROUND

1. Field of the Invention

The present invention relates to the field of control of electronic devices and, more particularly, to a method and apparatus for human users to download control data from an Electronic Device to a Local Display Device and subsequently control the Electronic Device from the Local Display Device.

2. Related Art

Electronic devices are frequently controlled remotely using what is commonly known as a “remote control”. These remote controls are typically small, lightweight, hand-held devices that contain buttons, knobs, and sliders that provide the user with the capability to control the device from a distance of at least a few feet. These remote controls usually do not include a display device, but rather rely on the user to watch a display on the actual device for feedback. Also, these remote controls typically use infrared signals for communication, requiring that the device and the remote control have line of sight to each other. Finally, these remote controls are usually designed to work with a single device, or at best a small family of related devices.

User-controlled electronic devices have unique user interfaces. Consider as a few examples: stereo components, security systems, telephones, and VCRs. Each model of each brand has a unique combination of buttons, dials, sliders, and displays to allow the user to access functions and information. Yet across this diverse set of products, the user interface contains only these few basic components. What varies is the number and size of each component, their layout, and how they are used to provide the functions and information. Because these factors vary, the electronics, software, and mechanical layout must be designed individually for each model. In addition, the electronics and control panel of the user interface must be manufactured for each individual item. These user interface design and manufacturing costs are expensive and unnecessary.

“Glass cockpits” are a recent trend in the aircraft industry to reduce user interface costs. This term refers to the replacement of several special-purpose gauges in the cockpit with a few general-purpose displays that are capable of displaying the same information as the gauges, when the pilot requests it. The information is now collected, formatted, and displayed under software control. In addition, many physical controls have been replaced by “virtual controls” that are shown on the displays when needed, and selected by the pilot using a touch screen or a cursor. Glass cockpits have greatly reduced the cost of modem cockpits by eliminating many physical devices. In addition they have simplified the pilot's task by providing a common look and feel to many input and output items. Finally, they have greatly enhanced the flexibility of the cockpit: by placing the look and feel of the displays and controls under software control they can be more readily changed and expanded than with physical devices.

A related concept can be applied to universal control of household and workplace electronics. Imagine the physical user interface of all common electronics being replaced by a single general-purpose electronic device that has a display and a touch screen or a cursor. A device having this capability is referred to herein as a “local display device.” Devices to be controlled by the local display device are hereinafter referred to as “electronic devices”.

While the local display device could be a desktop PC, portability is a valuable feature to allow a single local display device to be used with all common electronics. Using a general-purpose device such as a PDA, handheld computer, or cell phone as the local display device offers handheld portability and also provides cost advantages since these devices are already widespread and can be used for many other applications. This is especially true if any general-purpose device (PDA, cell phone, PC, laptop) could be used as the local display device. The local display device needs a means to connect to each electronic device that it is controlling. This could be done with a cable, but a more practical approach is a communication protocol such as Bluetooth, IrDA (for infrared), or IEEE 802.11, which are protocols for wireless networks, that facilitate greater portability and ease of use than cables.

The local display device needs software that can display the user interface of each electronic device and allow the user to interact with and control the electronic device. One approach is to load a user interface program for each electronic device on the local display device, much as software is installed on PCs or PDAs today. This approach lacks flexibility, since it must be decided in advance which electronic devices will be controlled. It also restricts usability, since the user is responsible for installing the software on the local display device, and many people have difficulty installing software. In addition, permanently installed software consumes memory space, which is already severely limited on PDAs, handheld computers, and cell phones. Since there are many brands and models of PDAs, handheld computers, cell phones, laptops, PCs, and other potential local display devices, each electronic device manufacturer would need to provide numerous versions of the user interface programs and numerous sources of the programs to insure that all users could obtain and install them. This approach also does not provide any hope of a common look and feel for all user interfaces, since each user interface program could implement a unique set of controls.

An alternative approach, that resolves some of these limitations, places the user interface program on the electronic device, and makes the electronic device responsible for installing it on local display devices. With this technique, when a local display device establishes contact with the electronic device, the electronic device installs the user interface program on the local display device. This type of approach is disclosed in U.S. Pat. No. 6,020,881. Numerous limitations still exist with this approach. For example, if the user interface program is permanently installed, large amounts of valuable memory are consumed, especially when several electronic devices have their user interface programs installed. Moreover, because the user interface is typically an executable program, the electronic device must store multiple versions and somehow determine the type of local display device that is being used so that it installs the correct version.

Alternatively, as implied in the previously mentioned patent, only one type of local display device can be used, so that the electronic devices only need a single version of their user interface program. In any event, since executable programs may be large, long delays may result during installation, and for multiple electronic devices, significant amounts of memory are still required. Finally, although the previously mentioned patent describes a specific look and feel for the user interface, there is no guarantee that the individual user interface programs of the electronic devices will conform to this style.

### SUMMARY OF THE INVENTION

In an attempt to solve some of the foregoing limitations, a system and method for providing universal control of electronic devices includes a local display device having a simulator and a guide. The simulator simulates controls for electronic devices and enables a user to control electronic devices through the simulator. The guide gives assistance to the user in control of various electronic devices through textual and/or audible instruction.

In understanding the operating principles of the present invention, it is useful to compare the user interface paradigm described above to the paradigm of accessing the World Wide Web with PCs. In this comparison, PCs are analogous to the local display device, and web sites are analogous to electronic devices. In the Web, the user needs a way to easily view and interact with web sites. What has made the Web so accessible and popular, even for unsophisticated users, is the Web browser. The browser is a general-purpose “viewer” that provides a common look and feel for Internet content. It is installed once, often at the PC factory, so that users need not deal with installation issues, or need deal with them only once. The variability in types of PCs is handled at installation, by installing the correct version of the browser. This is a one-time issue, and as stated previously is often handled by the factory rather than the end user. When directed to a particular web site, the browser and web server interact transparently to the user to provide a user interface to the web site. The browser downloads a text file (HTML page) from the server, and the text file specifies to the browser how to display the web site to the user. The text files use a standard format that is understood by every browser version, so the web site need only store a single version of the text file. This is much more effective than having each web site download an executable program to the PC, which would be much more time consuming and error prone than downloading a text file in a format common to all browsers. Finally, the browser stores the data files locally, but can be configured to delete the data files at the end of each session, to reduce memory consumption.

The method and apparatus of the present invention uses an approach analogous to the World Wide Web browser paradigm. According to one embodiment of the present invention, a local display device includes a software program that provides the user interface (and other capabilities) as a simulation viewer installed on the local display device. Many different types of local display devices (e.g., PDA, cell phone, laptop computer) can be supported by having multiple versions of the simulation viewer, and installation is a one-time issue that can be done at the factory or by the user. The simulation viewer program of the present invention requires less memory than would be required for two or more programs containing the user interfaces for specific electronic devices. The local display device establishes communications with an electronic device using a standard protocol such as Bluetooth, IEEE 802.11, IrDA, RS232, or Ethernet, and downloads a small data file, called a simulation configuration file, from the electronic device to the local display device. This data file provides information that specifies how the simulation viewer should display the electronic device control interface to the user. The simulation viewer provides a common look and feel for the user interfaces of all types of electronic devices. The simulation configuration file may also specify how to present information, demonstrations, help, and how to control the electronic device. If and when the local display device loses communication with the electronic device, the data file is deleted from local display device memory, thereby freeing space for data files of other electronic devices. Additionally, development of new user interfaces and other help and control functions for electronic devices is simplified because much of the functionality is provided in the simulation viewer. In addition, manufacturing costs of the electronic devices are greatly reduced because the need for physical buttons, knobs, sliders, and displays may be eliminated.

For a set of related electronic devices, such as the components of a home entertainment system, the simulation configuration file may specify how to control all of the electronic devices as if they were a single electronic device. The local display device establishes communications with all of the electronic devices. When the user performs a control function using the local display device, such as increasing the volume, changing the channel, or playing a movie, the local display device sends the command to the appropriate device, be it the tuner, television, VCR, or DVD player.

The simulation viewer program of a preferred embodiment of the invention is implemented as a viewer of state machine simulations. This is a very general-purpose mechanism for representing and controlling devices. Simulation is a proven mechanism for training people to use devices, as demonstrated by the airline industry and flight simulators. Guided simulation has conventionally been used over the Internet for training and marketing of products. Simulation lends itself to demonstrating and helping users with the operation of devices. It provides extreme flexibility while enforcing a common look and feel.

The present invention defines a method and apparatus that gives a human user universal control of electronic devices using a local display device including a simulation viewer that provides a means for flexible and cost-effective control. According to a preferred method and system of the present invention, each electronic device has the capability of establishing a communications network with other devices. When the local display device establishes a network connection with an electronic device, the electronic device sends its identifier to the simulation viewer software resident on the local display device, which displays the identifier.

When the user selects the identifier on the local display device, the simulation viewer software requests and receives a data file, referred to as a “simulation configuration file,” from the electronic device over the communications network. The simulation configuration file allows the simulation viewer software to simulate, for example, the appearance and functions of that particular electronic device on the local display device. The user then interacts with the simulation, which may include obtaining information about and controlling that particular electronic device. The simulation viewer software, via user selection, issues appropriate commands and data via the communications network to effect control of the electronic device. The simulation viewer software receives data and status from the electronic device, via the network, and updates the display and simulation status. When the local display device departs the communications network, the simulation viewer software preferably deletes the identifier, simulation configuration file, and all displayed information of the electronic device to ensure sufficient memory for subsequent electronic device simulations. Accordingly, the apparatus, method and system of the present invention allows a user to control many different electronic devices using a single local display device.

According to one aspect of the invention, the simulation viewer software may include two parts; the first part, the Simulator, displays a graphical depiction of the electronic device on the local display device, and the second part, the Guide, provides informational assistance on control of the electronic device.

For the Simulator, certain active regions of the graphical depiction can be selected by the user with an input device, and when so selected, cause the graphical depiction to change appearance as defined by the simulation configuration file. These selections may also cause data (including commands) to be issued to a control program of the electronic device, which receives and stores the data and executes the commands. The Simulator also receives data and status updates from the electronic device, and updates the simulation and display accordingly.

The Guide assists the user in performing specific tasks with the simulation. For example, the user may request that the Guide: (1) demonstrate or perform a single step of a particular task; (2) demonstrate or perform an entire task step by step, while displaying and verbalizing a description; or (3) the user may ask the Guide for a hint at any step. The Guide may also act to prevent the user from taking any step that does not lead toward fulfillment of a task.

### BRIEF DESCRIPTION OF THE DRAWING

Preferred embodiments of the invention will now be described with reference to the drawing figures, wherein like designation denote like elements and wherein:

FIG. 1 is a block diagram illustrating a universal control system according to a preferred embodiment.

FIG. 2 is a block diagram illustrating components of the hardware and software of the universal control system of FIG. 1;

FIG. 3 is a flow diagram illustrating a method for controlling electronic devices with a local display device according to one preferred embodiment of the invention.

FIG. 4 is a flow diagram illustrating the method for the user quitting the simulation, or the local display device leaving the communications network of an electronic device;

FIGS. 5A-C are block diagrams illustrating various implementations of a universal control system according to the present invention;

FIGS. 6A-C show a graphic user interface and method of using a local display device according to a preferred embodiment of the present invention;

FIG. 7 is a flow chart illustrating a method of using a local display device according to various aspects of the present invention;

FIGS. 8A-D are flow diagrams illustrating methods of using a Simulation Viewer including a guided simulation of an electronic device;

FIG. 9 is a view of a local display device simulation viewer as a user selects a specific electronic device to control;

FIG. 10 is a view of a local display device of the present invention including a Simulation Viewer as it begins the simulation of an Electronic Device;

FIG. 11 is a view of a local display device simulation viewer showing an example description text bubble;

FIG. 12 is a view of a local display device simulation viewer showing an example hint text bubble; and

FIG. 13 is a view of a local display device including command menu.

FIG. 14 illustrates the format and contents of the simulation configuration file for an electronic device.

### DETAILED DESCRIPTION OF THE PREFERRED EMBODIMENTS

The Universal Control System of the present invention includes a local display device, at least one electronic device to be controlled by the local display device, and a communications network over which control and display information is communicated there between. The local display device of the present invention includes a simulation viewer that uses software elements that reside on and are processed by commonly available computing hardware to enable universal control of electronic devices. Communications between the local display device and electronic devices is facilitated via communications protocols to allow users to simulate and establish control via simulation of the electronic devices.

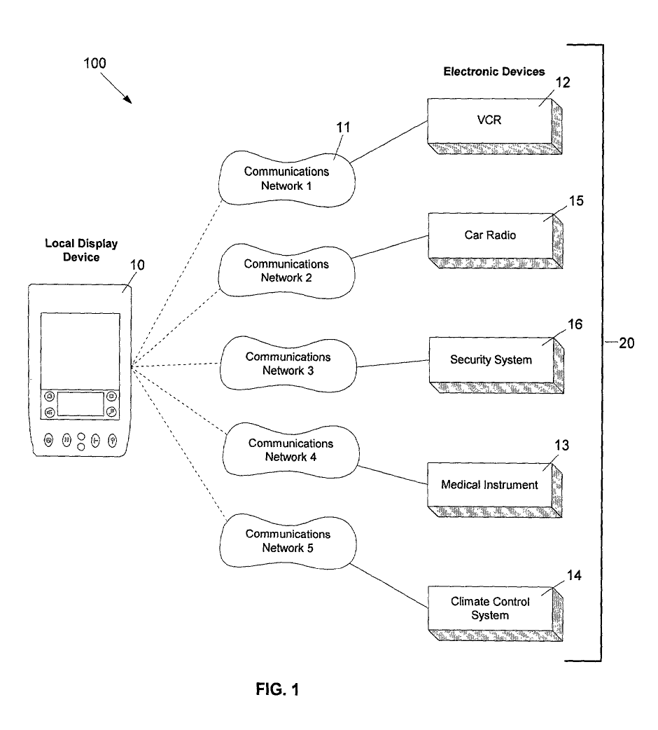

FIG. 1 illustrates an example embodiment of a universal control system 100 of the present invention. Local display device 10 (LDD) is an electronic component that includes a computer processor. In the preferred embodiment, LDD 10 is a Pocket PC Personal Digital Assistant (PDA), but could be any general computing device as described further below.

Electronic devices 20 may be any electronic device of a specific purpose, over which the human user desires to exert control, including for example, VCR 12, Security System 16, climate control system 14, car radio 15, irrigation control system, television, digital video disk player, home stereo system, home appliances such as a dishwasher, automotive electronics, medical instruments, communications equipment, and industrial machinery. Local display device 10 communicates with electronic devices 20 via communications network 11. Communications network 11 is preferably a wireless network but may be any communications mechanism utilizing any type of communication protocol. In fact, the communications network 11 does not have to be wireless and could be any connection means that permits communications, such as the bus of a computer. Communications network 11 may be a single network as well as a plurality of networks as shown in FIG. 1.

Preferably, the communication protocol for communications network 11 is Bluetooth as disclosed in the Specification of the Bluetooth System, v.1.1., by the Bluetooth Special Interest Group. Bluetooth is a digital wireless protocol adopted by several hardware manufacturers to enable various mobile devices such as smart phones, smart pagers, handheld PCs, notebooks, etc., to keep data consistent from one device to another. Bluetooth currently operates using FM modulation combined with frequency hopping to decrease interference and provides for a gross data rate of 1 Mbps.

It should be noted that the present invention does not limit the communications network 11 to use the Bluetooth protocol, as any communications protocol, such as ethernet, infrared, combination of protocols, or any other conventional protocol can be used.

In the preferred embodiment, a user would carry a Bluetooth-enabled local display device 10, for example a PDA as shown in FIG. 1. When the user came within range of a Bluetooth-enabled electronic device 20, such as a VCR 12, the Bluetooth protocol establishes communications network 11 between the local display device 10 and VCR 12 (e.g., via network 1). Through the universal control system 100, VCR 12 would then grant control of itself to the local display device 10, so that the human user is able to control VCR 12 through local display device 10. How this control is granted will be described in detail later.

When the user carries the local display device 10 within range of another Bluetooth-enabled electronic device 20, such as a security system 16, that electronic device 20 also establishes communications over communications network 11 (e.g., network 4) with local display device 10 and grants control of itself to local display device 10. Local display device 10 could be any general-purpose computing device, such as a PDA, laptop computer, cell phone, as well as being a stand-alone device.

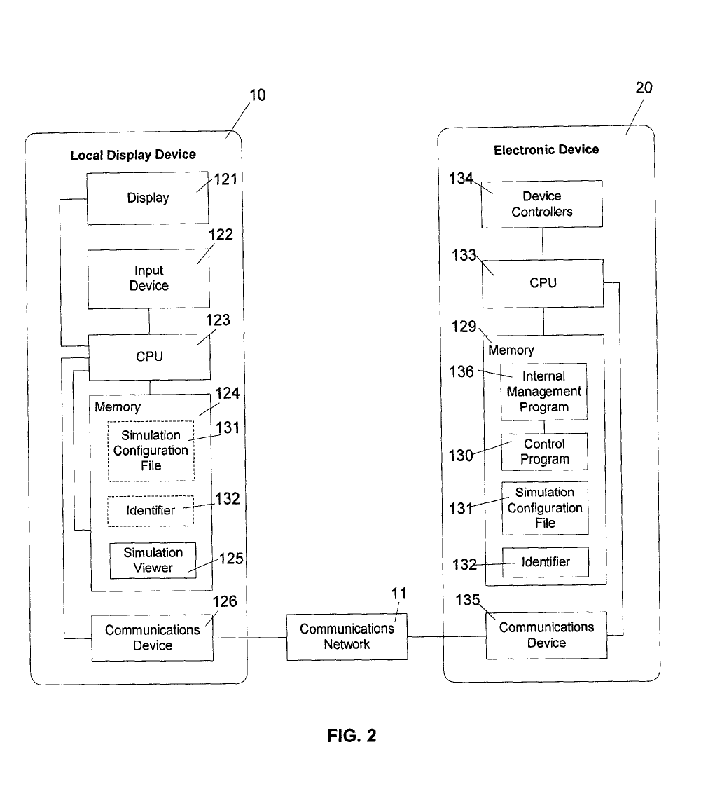

FIG. 2 shows components of the universal control system 100 hardware. Local display device 10 preferably contains hardware that includes central processing unit (CPU) 123, and coupled to the CPU 123 are a memory 124, display 121, input device 122 for receiving input from the user, and communications device 126. Electronic device 20 preferably contains hardware including CPU 133, and connected to the CPU 133 are memory 129, communications device 135, and optionally, device controllers 134.

Communications device 126 in the local display device 10 must support the same protocol as the communications device 135 in the electronic device 20. Communications devices 126 and 135 include both hardware and software configured to receive and transmit messages over communications network 11 between the LDD 10 and electronic device 20.

FIG. 2 also shows software components of the universal control system 100. These software components preferably include: a simulation viewer program (hereafter “Simulation Viewer”) 125, Simulation Configuration File 131, Electronic Device Identifier 132, and Control Program 130. In a preferred embodiment, Simulation Viewer 125 and the Control Program 130 are written using Microsoft Embedded Visual C++ version 3.0, and run on the Windows CE version 3.0 operating system. Simulation Viewer 125 is a software program that resides in the Local Display Device memory 124. It is installed there using any technique known in the art for installing software. In the preferred embodiment, Simulation Viewer 125 is installed on the Pocket PC (Local Display Device 10) using the Microsoft .CAB file technique and the Microsoft Application Manager, as disclosed in the documentation that is included with the Microsoft Embedded Visual C++ version 3.0 development environment.

Using this technique, the Pocket PC is connected via a serial port to a standard desktop PC. The .CAB file exists on the desktop PC, and contains Simulation Viewer 125, and other data and programs necessary for the installation. Using the desktop PC, a user indicates their desire to install the Simulation Viewer 125 on the Pocket PC (LDD 10). This starts the Application Manager program, which uses the .CAB file to download the Simulation Viewer program to the Pocket PC (LDD 10).

Simulation Viewer 125 has the capability to display information about, and allow control of, electronic device 20 when properly enabled using information from simulation configuration file 131 of electronic device 20. Simulation Viewer 125 does this by simulating the electronic device 20 on the local display device 10 using information from a specific simulation configuration file 131 of electronic device 20, and sending appropriate data and commands to the electronic device 20 based on the user's interaction with the simulation. To do this for a specific electronic device 20, Simulation Viewer 125 needs a specification of that electronic device 20. These specifications are contained in the Simulation Configuration File 131 for each electronic device 20. Simulation Configuration File 131 is a data file that is stored in the memory 129 of each electronic device 20. Identifier 132 is a data file that contains a brief description of the electronic device 20, for example, the name and type of device, and also resides permanently in the memory 129 of electronic device 20.

Control Program 130 is a software program that resides in memory 129 of electronic device 20. Its purpose includes but is not limited to: (1) granting control of electronic device 20 to Simulation Viewer 125; and (2) providing a software interface between Simulation Viewer 125 and electronic device 20. When local display device 10 establishes communications network 11 with the electronic device 20, Control Program 130 sends Identifier 132 to Simulation Viewer 125 of LDD 10. When Control Program 130 receives a request from Simulation Viewer 125 on LDD 10 for Simulation Configuration File 131 via Communications Device 135, Control Program 130 performs any password verification that may be required, and sends Simulation Configuration File 131 to local display device 10 via Communications Devices 135, 126 thereby granting control of the electronic device 20 to Simulation Viewer 125 on local display device 10.

When the user generates parameters and commands through interaction with Simulation Viewer 125, Simulation Viewer 125 sends these as data messages to local display device's Communications Device 126, which sends them through communications network 11 to the electronic device's Communications Device 135, where they are routed to Control Program 130. Control Program 130 then interprets these data messages and takes action causing the parameters to be set and the commands to be executed within the electronic device 20. Control Program 130 accomplishes this by generating the appropriate commands to Internal Management Program 136, which manages the various components of electronic device 20 via device controllers 134. For example, in VCR 12, Internal Management Program 136 would execute a tape play command by sending a command to a device controller of the tape motor to begin turning in a forward direction at a certain speed, and by sending a command to another device controller of the tape head to move to a read position and begin reading the tape. Internal Management Program 136 sends status and updated parameter settings to Control Program 130, which formats them as data messages and forwards them to Simulation Viewer 125 via Communications Device 135, Communications Network 11, and Communications Device 126 of LDD 10.

When local display device 10 joins communications network 11 of electronic device 20, Simulation Viewer 125 acquires Identifier 132 of electronic device 20 and temporarily stores it in memory 124 (shown in dashed lines in FIG. 2). Simulation Viewer 125 provides information via CPU 123 to display 121 so that Identifier 132 of electronic device 20 is displayed for a user. If the user selects the displayed electronic device identifier (e.g., touching it on a touch screen, pointing to it with a PDA stylus, entering numbers into a keypad, etc.) showing that he is interested in controlling or learning more about that particular electronic device 20, Simulation Viewer 125 retrieves the Simulation Configuration File 131 associated with that particular electronic device 20, stores the retrieved Simulation Configuration File 131 in memory 124, and begins to run the simulation of electronic device 20 as specified by the data in the Simulation Configuration File 131, thereby providing the user with full information and control of electronic device 20.

The user may quit the simulation at any time. Simulation Configuration File 131 and Identifier 132 remain resident in memory 124 as long as the LDD 10 remains on communications network 11 of electronic device 20, allowing the user to control electronic device 20 at any time. When LDD 10 leaves the communication network 11 of electronic device 20 (e.g., by leaving the range of communications network 11 or turning off LDD 10), Identifier 132 and Simulation Configuration File 131 are either erased or not refreshed, depending on the type of RAM used, thereby removing them from LDD memory 124.

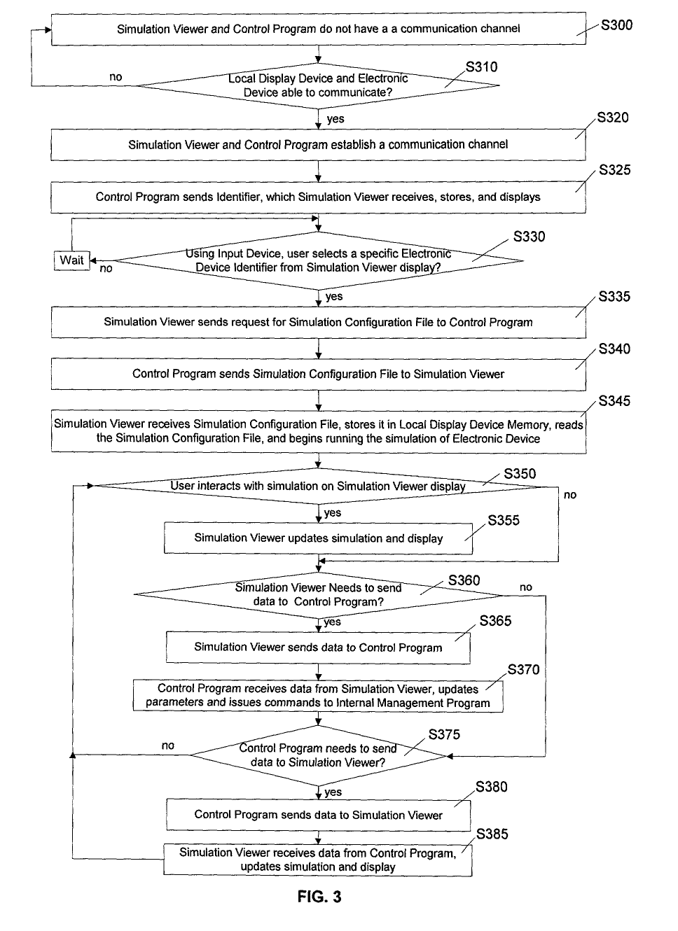

FIG. 3 is a flow diagram illustrating a method of controlling electronic devices 20 with a local display device 10 including a Simulation Viewer 125. Initially the local display device 10 and the electronic device 20 are not connected in any way and cannot communicate with one another, so that Simulation Viewer 125 and Control Program 130 do not have a communication channel S300. When using Bluetooth protocol, this would occur when the LDD 10 was beyond the communication range of the Bluetooth (currently, approximately 10 meters) enabled communication device 135 in electronic device 20. When LDD 10 and electronic device 20 are within range to begin communicating S310, Simulation Viewer 125 and the Control Program 130 establish communication channel S320. Once the communication channel is established, the Control Program 130 sends Identifier 132, which the Simulation Viewer 125 receives, stores in memory, and displays S325. The user is able to see Identifier 132 on display 121 and, if he wants to view information about or control the corresponding electronic device 20, he selects Identifier 132 using input device 122 (S330). Simulation Viewer 125 then sends a request via communications network 11, to Control Program 130 for its Simulation Configuration File 131 (S335). Control Program 130 receives the request and sends Simulation Configuration File 131 to the Simulation Viewer 125 (S340).

Once the Simulation Configuration File 131 is received, it is stored in memory 124, LDD 10 begins running the simulation of the electronic device 20 as defined by the information in Simulation Configuration File 131 (S345). Using the display 121 and input device 122 of the LDD 10, the user interacts with the displayed simulation of the electronic device 20 to view information and guided demonstrations, request help, set values, and issue commands S350. Input device 122 is preferably a touch screen in a PDA or similar device (as discussed below), but may be any known electronic or mechanical means for entering a selection on LDD 10. Simulation Viewer 125 updates the simulation and display as the user interacts S355. If the Simulation Viewer 125 needs to send parameters and commands to Control Program 130 in the form of data S360, it does so S365. In this case, Control Program 130 receives data from Simulation Viewer 125, and uses that data to update parameters, and issue appropriate commands to Internal Management Program 136 of electronic device 20 (S370). If some parameters or status are updated in the electronic device 20, then Control Program 130 may need to send data to the Simulation Viewer 125 (S375), which it does in step S380. When Simulation Viewer 125 receives data from Control Program 130, it updates the simulation of electronic device 20 on display 121 (S385).

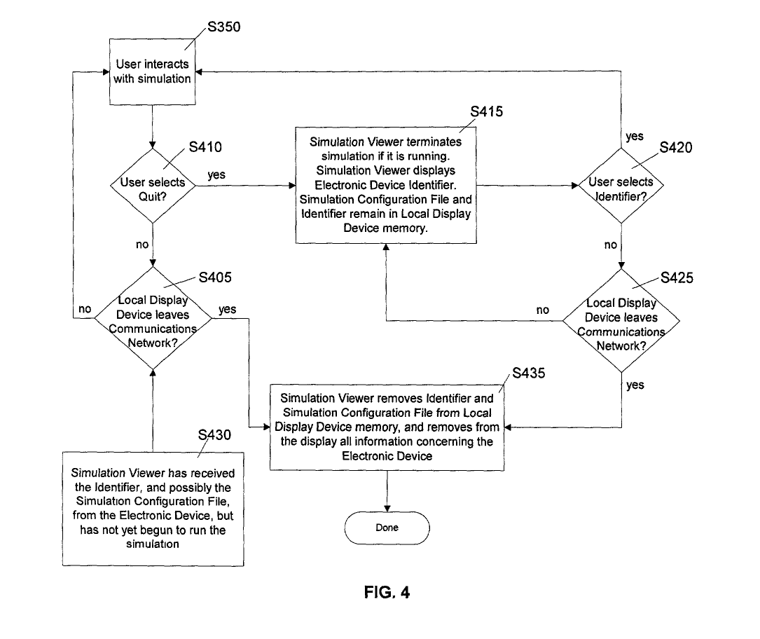

FIG. 4 illustrates a method of control with a universal control device when the local display device 10 leaves communications network 11 of the electronic device 20 (S405), or alternatively, when the user quits the simulation S410. If the user selects ‘Quit’ S410 (e.g., via input device 122) while interacting with the simulation, Simulation Viewer 125 terminates the simulation of the electronic device 20, but preferably continues to display Identifier 132 for electronic device 20, and allows both Identifier 132 and Simulation Configuration File 131 to remain in memory 124 (S415). At this point, the user has the option of selecting Identifier 132 (S420) and begins interacting with the simulation for controlling electronic device 20 again. If the local display device 10 loses contact with electronic device 20 by leaving communication network 11 of the electronic device (S405 and S425), either before the Simulation Viewer begins to run the simulation the first time while the user is interacting with the simulation S430, or after the user has selected ‘Quit’ S410, the Simulation Viewer deletes Identifier 132 and Simulation Configuration File 131 from memory 124, and removes from the display all information concerning the electronic device 20 (S435). In the case of a Bluetooth enabled device, LDD 10 would leave the communications network when the user carried it beyond the communication range of communications network 11. To regain control of the electronic device 20, the user needs to cause the LDD 10 to be within range of communications network 11 of electronic device 20.

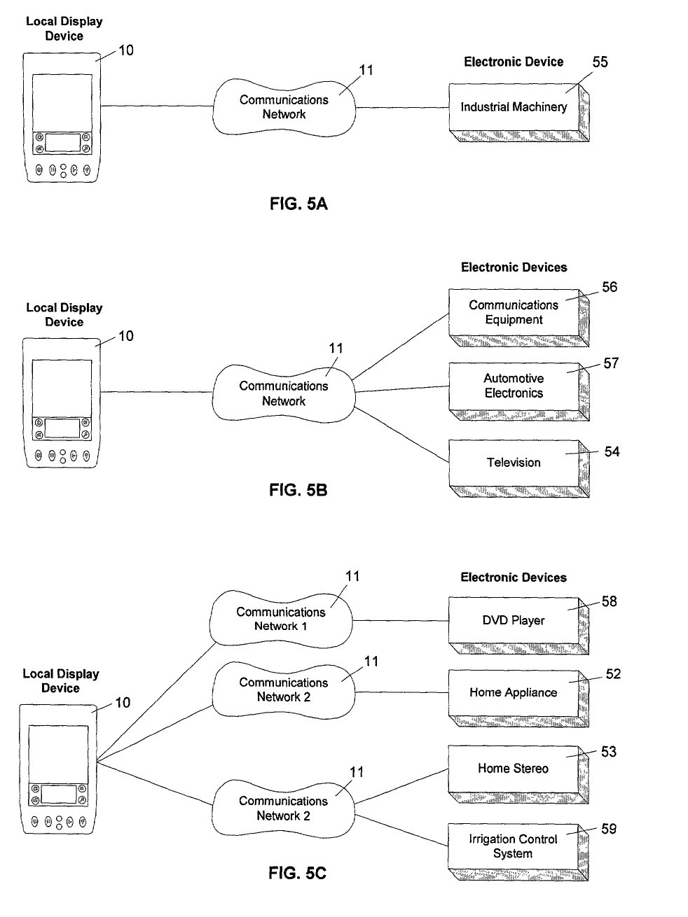

The local display device 10 may be connected to a single electronic device 20, through communications network 11, for example, Industrial Machinery 55 as shown in FIG. 5A. Alternatively, the LDD 10 may be connected to more than one electronic device 20, for example, Communications Equipment 56, Automotive Electronics 57 and Television 54, through a single communications network 11 as shown in FIG. 5B. The LDD 10 may be connected to more than one electronic device 20, for example, DVD Player 58, Home Appliance 52, Home Stereo 53, and Irrigation Control System 59, through multiple communications networks 11 as shown in FIG. 5C. In all cases, communications devices 126 and 135 in the respective local display device 10 and in the electronic devices 20 handle the details of network communications. Simulation Viewer 125 may receive Identifiers 132 for zero, one, or several electronic devices 20 via the one or more communications networks 11. Display 121 of LDD 10 preferably displays all of the Identifiers 132 that it has acquired from electronic devices 20, so that the user may select any desired electronic device 20 to simulate and control.

For a set of related electronic devices 20, such as the components of a home entertainment system, the Simulation Configuration File 131 may specify how to control all of the electronic devices as if they were a single electronic device. The local display device 10 establishes communications with all of the electronic devices 20. When the user performs a control function using the LDD 10, such as increasing the volume, changing the channel, or playing a movie, the LDD 10 sends the command(s) to the appropriate electronic device(s) 20, be they the tuner, television, VCR, or DVD player.

Simulation Viewer 125 is a program that contains many functions including, simulating electronic devices 20, sending data (including parameter settings and commands) to electronic devices 20 via communications device 126, receiving data (including updated parameter settings and status) from the electronic devices 20 via the communications device 126, displaying graphical entities on display 121 representing the simulation of electronic devices 20 and data received from electronic devices 20, and guiding users as they interact with the simulation and electronic devices 20.

Simulation Configuration File 131 is a data file that configures the functions of Simulation Viewer 125 with data, thereby enabling it to perform a guided interactive simulation of a specific electronic device 20.

The purpose of Simulation Viewer 125 includes but is not limited to: 1) displaying Identifiers 132 of all electronic devices 20 in communication with LDD 10 on display 121; (2) providing a simulated graphical depiction as well as sound for controls of electronic device 20; 3) allowing the user to interact with and control electronic device 20 by using input device 122 to select active regions within the graphical depiction on display 121 and sending corresponding parameters and commands to the electronic device 20; and 4) presenting guidance on using each communicating electronic device 20, in the form of text and audible speech.

As previously mentioned, Simulation Viewer 125 may contain two basic parts: a simulator component (hereafter Simulator) and optionally, a guide component (hereafter Guide). The Simulator provides information for displaying the graphical depiction of each electronic device, generates sounds, handles the user interaction with the graphical depiction, and handles the communications with the electronic device 20 as discussed above. On the other hand, the Guide provides guidance in the use of the LDD 10 to control electronic devices 20.

Now, a description of a Simulator according to a preferred embodiment of the invention will be described. The Simulator generates a graphical depiction of the electronic device by displaying one or more graphical entities on the display. A graphical entity may include, but is not limited to, one of the following: a bitmap, a digital image, a graphical shape, text and numbers. The graphical entities may represent the appearance, process, and controls of the electronic device in communication with the local display device. The graphical entities representing the electronic device may be changed and/or updated throughout the course of the interactive simulation with the electronic device by replacing one or more displayed graphical entities with other graphical entities, and/or overlaying one or more graphical entities on top of currently displayed graphical entities. In a preferred embodiment of the present invention, this is done using a technique known as a z-ordered display list, as disclosed in the article “Animation in Win32” by H. Rodent Microsoft Developers Network Library (July 1997), which is incorporated herein by reference. In this technique, visible graphical entities are added to the end of the display list when they are first shown on the display. They are removed from the display list when they are removed from the display. When a portion of the display needs to be redrawn, the drawing routine steps through the display list in order from beginning to end, and draws in a temporary buffer, the portion of each graphical entity that falls within the area of the display being redrawn. Once the end of the list is reached, the temporary buffer is copied to the display. This display technique is well known and thus will not be explained in detail.

The Simulator may also use data that is a digital representation of sound waves to produce audible sound. In the preferred embodiment of the invention, the Simulator uses data in .WAV format that represents sound waves, and calls the PlaySound function in the Microsoft Embedded Visual C++ version 3.0 system, to produce audible sound from the .WAV data. Information pertaining to graphical entities, how they change, and digital sound wave data specific to the simulation of an electronic device are contained within the Simulation Configuration File 131 of each electronic device.

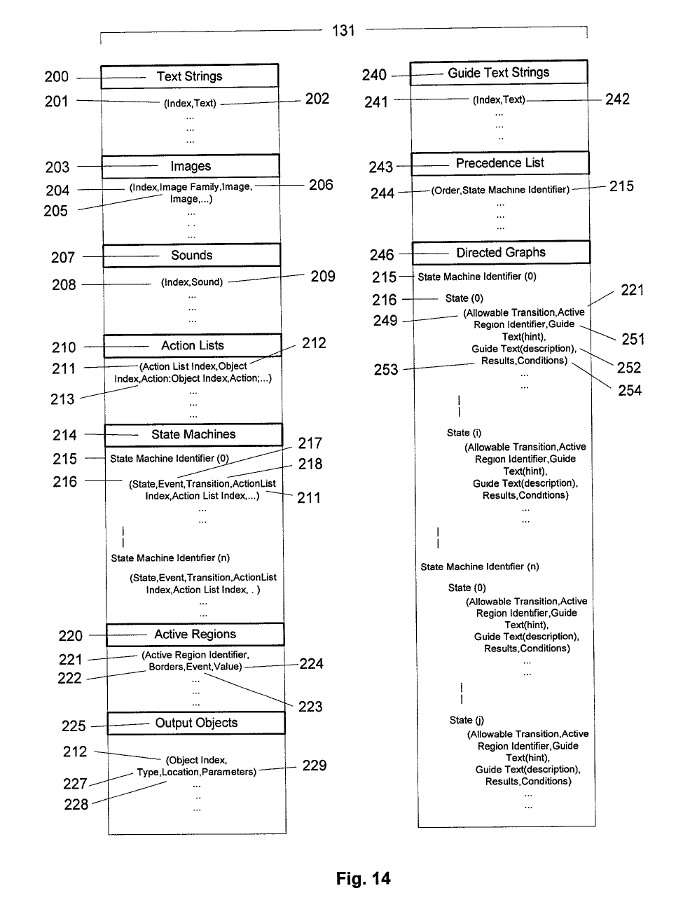

Each Simulation Configuration File 131 contains symbolic descriptions of one or more Electronic Devices 20 that are being controlled. The basic structure of a Simulation Configuration File 131 is shown in FIG. 14. In the preferred embodiment of the present invention, a Simulation Configuration File 131 has two main divisions, each having several sections. The first division pertains to the simulated appearance and behavior of the Electronic Devices 20. The Text Strings 200 section has all of the textual data used in the simulation of the Electronic Devices 20. Each entry has an Index 201, by which it is referred to in the other sections, and the Text 202 itself. The Images 203 section contains a digital representation of every image that is used in the simulation. Each entry has an Index 204, by which it is referred to in the other sections, an Image Family 205 identifier, and every Image 206 in the Image Family 205.

Every Image 206 in the Image Family 205 has common attributes, such as size, number of bits representing each color, and compression scheme, such as JPEG, bitmap, or run-length encoding. The Sounds 207 section contains a digital representation of every sound that is used in the simulation. Each entry has an Index 208, by which it is referred to in the other sections, and a digital encoding of a Sound 209 segment. The Action Lists 210 section contains lists of specific actions to be performed on specific Output Objects 225, grouped together in their order of execution. Each entry has an Action List Index 211, by which it is referred to in the other sections, followed by a list of one or more Object Index 212/Action 213 pairs. Each pair contains the Object Index 212 of a specific Output Object 225, and an encoding of an Action 213 to be performed on the object, along with any data needed for the action. (An example would be to display the 5^{th} frame in a particular sequence of images.)

The State Machines 214 section contains representations of the one or more state machines that describe the behavior of the Electronic Devices 20. Each state machine has a State Machine Identifier (0-n) 215, followed by a list of entries that describe what happens when a specific Event 217 occurs while the Electronic Device 20 is in a specific State 216. Each entry has a State 216 number and an Event 217 number, followed by the number of the state to which a Transition 218 would be made, along with a list of Action List Indexes 211 to be performed when the transition is made. The Active Regions 220 section contains a list of all active screen regions with which the user interacts. Each entry has an Active Region Identifier 221, by which it is referred to in the other sections, a description of the Borders 222 of the region, an Event 223 number which is issued when the user selects a point inside of the Borders 222 of the region, and a Value 224 to be used in any actions performed as a result of the Event 223.

The Output Objects 225 section contains a list of all elements of the simulation that are displayed or utilized during the execution of the simulation. Each entry has an Object Index 212, by which it is referred to in the other sections, followed by the Type 227 of object it is, such as an image sequence, a text sequence, an integer, a counter, or a graphical shape, and its Location 228 on the screen. Each entry also contains Parameters 229 that refine the definition of the specific object based on its Type 228, such as number of elements, maximum value, time interval between elements of a sequence, and Events 217 to be issued when specified conditions are met.

The second division of the Simulation Configuration File 131 pertains to the way the Guide instructs the user of the Electronic Devices 20. The Guide Text Strings 240 section has all of the textual messages that are presented to the user by the Guide during the operation of the Electronic Devices 20. Each entry has an Index 241, by which it is referred to in the other sections, and the Text 242 itself. The Precedence List 243 section specifies the order in which the State Machines 214 need to be completed for proper operation of the Electronic Devices 20. Each entry consists of the Order (0-n) 244 in which the specified State Machine 214 is to be completed followed by its State Machine Identifier 215. The Directed Graphs 246 section describes the preferred way that the user should interact with the Electronic Devices 20 to accomplish some specific functions. Each directed graph in this section defines a set of specific paths through the State Machines 214 corresponding to the desired functions. Each directed graph has a State machine Identifier 215 to which it refers, followed by a list of States 216 and their Allowable Transitions 249 to subsequent states. Each State 216/Allowable Transition 249 entry has the Active Region Identifier 221 of the region on the screen with which the user would interact to accomplish the transition, the Guide Text (hint) 251 which is the Index 241 of the Guide Text String 240 for the hint to be issued, the Guide Text (description) 252 which is the Index 241 of the Guide Text String 240 for the description to be issued, any Results 253 that must be achieved before the transition is allowed, and any Conditions 254 of the presentation of hints and descriptions, such as display times and placement of the messages on the screen.

The Simulation Configuration File 131 described above is only one example out of infinite possibilities for configuring the electronic devices 20 to be simulated by LDD 10. The Simulation Configuration File 131 of the preferred embodiment may also include additional information to facilitate the implementation of the method for simulating the Electronic Devices 20.

In the preferred embodiment of the present invention, LDD 10 is a PDA having a touch-screen display. Display and input of selection of a local display device will now be described with reference to the preferred embodiment which utilizes a touch-screen of a PDA, but it should be noted that the present invention is not limited to this type of input/display but rather can be implemented with any commonly available electronic hardware.

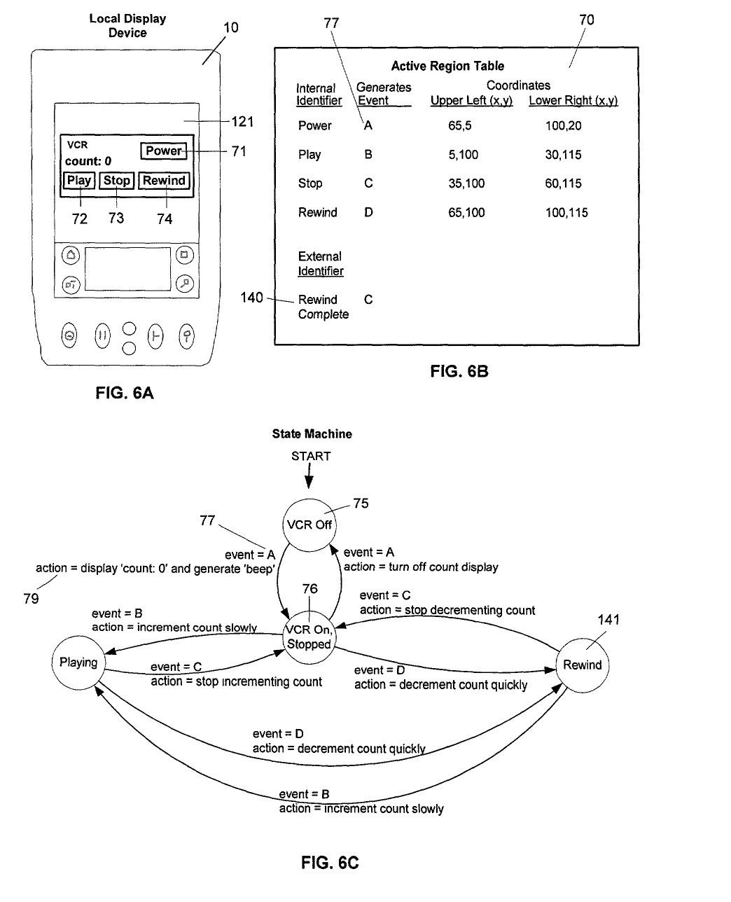

In LDD 10 active regions including the graphical depiction of VCR 12 in the simulation are defined by the coordinates of the boundary of the active region of display 121 as shown in FIGS. 6A-B. All active regions and their coordinates are read from the Simulation Configuration File 131 and stored in a table 70 within the Simulator. The Simulator detects when the user makes a selection with the input device, and compares the coordinates of that selection against all active regions in the table to determine which, if any, active region was selected. In the preferred embodiment, the Simulator receives a message from the Windows CE operating system whenever the user makes a selection with the input device. This message contains the coordinates of the selection. Each active region is represented as an object known as a CRgn in Microsoft Embedded Visual C++ version 3.0. For each active region, the Simulator calls the function PtInRegion to determine whether or not the coordinates of the user selection are within the region.

When the user selects an active region, the Simulator changes the graphical depiction of the electronic device and generates sounds, much as the appearance and sound of the actual electronic device would change. To enable the user selections to cause changes in the graphical depiction and sounds, the Simulator employs a technique known in the art as a state machine. The preferred embodiment uses a specific type of state machine known as a Mealy machine, as disclosed in the text Digital System Design by B. Wilkinson, Prentice/Hall International, 1987, on page 119. The present invention is not limited to using state machine techniques as any known form of logic control can be implemented to accomplish similar functionality.

It is known that a specific state machine defines a set of states, and a set of events that cause transitions between those states. In addition, a specific state machine defines actions that occur on the transitions between states. The Simulator represents the initial state of the state machine as a set of graphical entities that are displayed on the display 121 and sounds that are generated. When the user selects an active region, that selection generates an event in the state machine. If a transition is defined in the state machine from the current state to another state for that event, then the transition is made to the specified state, and the defined actions on the transition are performed. In the Simulator, defined actions include removing displayed graphical entities from the display 121, displaying new graphical entities on the display 121, generating sounds, setting values of items internal to the simulation, and sending data, including parameters and commands, to the electronic device 20. Thus the graphical entities and the sound definitions are coordinated with predetermined steps in the simulation, and predetermined graphical entities and predetermined sounds are produced during the simulation. Specific states, events, actions, graphical entities, and sound definitions that completely define the state machine for simulating a specific electronic device are listed in the Simulation Configuration File 131 for that electronic device 20.

FIGS. 6A-C shows an example simulation of VCR 12. The simulation begins in the “VCR Off” state 75 (FIG. 6C). When the user selects the active region “Power” 71 (FIG. 6A), event A is generated 77 (FIG. 6B). In the state machine, event A 77 causes a transition from the state “VCR Off” 75 to the state “VCR On, Stopped” 76, and the actions 79 defined on the transition are performed (“display ‘count: 0’” and “generate beep”). When in the start state (“VCR Off”) 75, if the user selected any of the active regions “Play” 72, “Rewind” 74, or “Stop” 73, nothing would happen in the simulation, because there is no transition from the “VCR Off” state 75 to another state for the events that these active regions generate.

The electronic device can also generate events that are used in the simulation. For example, in the Active Region Table 70 in FIG. 6B, there is an external identifier named “Rewind Complete” 140 that generates event C. If the electronic device is rewinding the tape and the rewind completes, it will send data to the Simulation Viewer indicating that the rewind is complete. The Simulation Viewer will convert this to Event C for the State Machine. If the State Machine is in the “Rewind” state 141 (upon entering Event D), Event C will cause it to go to the state “VCR On, Stopped” 76.

In the preferred embodiment, the Simulator and the Control Program use a technique known as Windows sockets to communicate between one another via the communications network 11. This technique is disclosed in the documentation included with Microsoft Embedded Visual C++ version 3.0. The Simulator acts as a server, and establishes a socket to listen for client devices. The Control Program acts as a client, and establishes a socket to request a connection to the server. When the local display device and the electronic device are able to communicate, due to physical proximity or a wired connection, the server accepts the client's request for a connection, and the socket is established between the Simulator and Control Program. Consequently, they may pass files and data between one another, until one or both close the socket, or until the physical (wireless or wired) connection is broken.

The purpose of the Guide is to assist a user in accomplishing a set of predefined tasks on the electronic device using the simulation on the local display device. The user may interact with the Guide in several ways. For example, the user can request that the Guide display a demonstration of an entire task, with explanations at each step. In this case, the Guide advances the Simulator through a series of steps in the simulation in response to the input by the user, displaying a textual message at each step, and may not send any data or commands to the electronic device. The user can also request that the Guide perform an entire task automatically, which the Guide does either with or without explanation depending on user preference. In this case, the Guide advances the Simulator through a series of steps in the simulation in response to the input by the user, possibly displaying a textual message at each step if explanation is desired, showing the results on the local display device, and also sending data and commands to the electronic device.

The user can also request that the Guide demonstrate the next step of a task, which the Guide does completely within the simulation with an explanation, not sending any data or commands to the electronic device. The user can also request that the Guide perform the next step of a task, which the Guide does within the simulation, displaying results and optionally an explanation, and also sending data and commands to the electronic device. The user may ask the Guide for a Hint at any step in the simulation, causing the Guide to generate a predetermined textual message regarding permitted active regions. Finally, if the user selects an active region that represents a valid action in the Simulator, but that is not a step that is allowed in the task, the Guide will block that action and generate a predetermined advisory textual message. All aspects of the Guide are configured by the Simulation Configuration File 131 transferred from the electronic device, including which steps are valid in completing the task, the explanations and help that the Guide provides (if any), and the tasks that may be performed with the Guide's assistance.

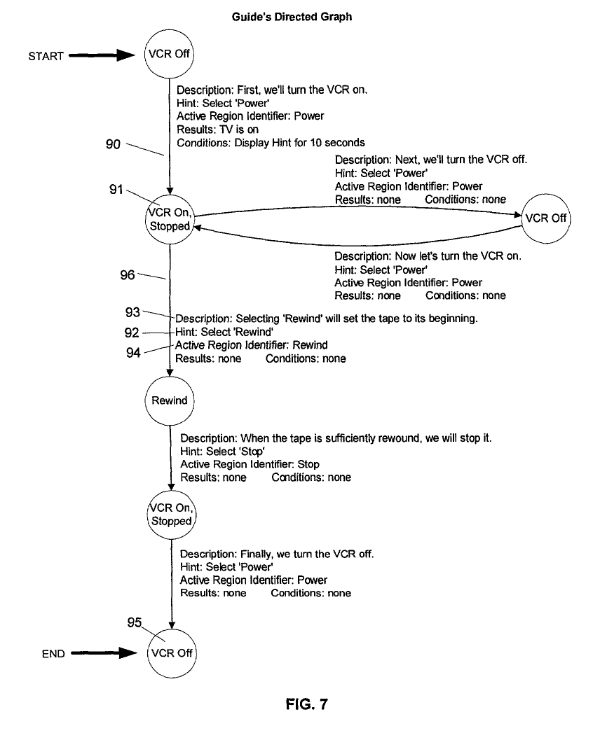

To assist the user, the Guide defines an ordered set of acceptable states and transitions within the Simulator's state machine that will accomplish the particular task. The Guide uses a technique known as a directed graph, as disclosed in the text Fundamentals of Data Structures by E. Horowitz and S. Sahni, Chapter 6, Computer Science Press, Inc., 1977. Using this technique, nodes of the directed graph represent acceptable states and the arcs of the graph represent acceptable transitions between states. FIG. 7 shows an example of a directed graph. The directed graph represents one or more paths through the state space of the state machine, representing one or more sets of actions that accomplish the task. One or more nodes in the directed graph are designated as end nodes 95, indicating that the task is complete. Arcs in the directed graph can include a textual description, a textual hint, an identifier for an active region, results that must be true before the transition will be allowed, and conditions of the presentation of hints and descriptions. Directed graphs, textual descriptions, textual hints, active region identifiers, results, and conditions specific to the guided interactive simulation of an electronic device, are contained in the Simulation Configuration File for that electronic device. The present invention is not limited to using a directed graph for the Guide, as other data structures may be used, such as trees, arrays, as well as any other known data structures.

When the user selects an active region, an event is input to the state machine in the Simulator, which checks that the event causes a transition to another state. If such a transition exists, then the Guide checks that the transition is acceptable. If the transition is acceptable, then the transition occurs, its associated actions are performed, and the current node in the directed graph is updated. If the transition is not acceptable, then the transition does not occur, and the Guide displays a message to the user.

FIG. 7 shows the Guide's directed graph corresponding to the state machine of FIG. 6C. In the start state “VCR Off” 75, if the user selects the “Power” active region 71, the state machine will verify that this causes a transition to another state. Next the Guide will check its directed graph and determine that this transition is acceptable 90, and the transition will occur. If the user then selects the “Play” active region 72, the state machine will verify that this causes a transition to another state. The Guide will check its directed graph and determine that this transition is not acceptable because no arc exists from the node “VCR On, Stopped” 91 to “Playing”. The transition will not be made, and the Guide will display a predefined message to the user, for example, “THIS IS NOT A VALID SELECTION! WOULD YOU LIKE SOME HELP?”

If the user asks for a hint, the Guide searches for the shortest path from the current node of the directed graph to the end of the graph, using a technique known as a breadth-first search, as disclosed in Fundamentals of Data Structures by E. Horowitz and S. Sahni, on pages 293-295. This search could use criteria other than shortest path; for example, each arc could include a cost or a value, and the search could find the lowest cost or highest value path. The Guide then displays to the user the textual hint from the next arc on the path. Optionally, the Guide can present the hint audibly using a text-to-speech engine. In the preferred embodiment, the Guide invokes a Microsoft text-to-speech engine where, by calling the function TextData with a text string as a parameter, the engine causes the text string to be spoken with a synthesized voice. In FIG. 7, assume that at the second node of the directed graph “VCR On, Stopped” 91, the user asks for a hint. The Guide will find that the next arc 96 on the shortest path to the end 95 contains the hint “Select Rewind” 92, which it displays to the user and presents audibly.

If the user asks the Guide to perform the next step automatically, the Guide performs the same search as described for a hint. The Guide then displays to the user the textual description from the next arc on the path, and preferably invokes a text-to-speech engine to present the description as audible speech. Finally, the Guide selects the active region whose identifier is included on the next arc on the path, causing the next step to occur. For example, as shown in FIG. 7, assume that at the second node of the directed graph “VCR On, Stopped” 91, the user asks the Guide to perform the next step automatically. The Guide will find that the next arc 96 on the shortest path to the end 95 contains the description “Selecting ‘Rewind’ will set the tape to its beginning” 93, which it displays to the user and presents audibly. Then the Guide selects the active region “Rewind” 94, causing the rewind to begin.

If the user asks the Guide to do the entire task automatically, the Guide repeatedly performs the next step automatically, as described in the previous paragraph, from the current node in the directed graph until an end node is reached.

If the user asks the Guide to Demo the entire task, the Guide repeatedly performs the next step automatically, as described in the previous paragraph. However, in this case, the Guide does not perform actions that send data or commands to the electronic device. Once the Guide completes the Demo, it resets the simulation to the state it was in when the demo began. Similarly, if the user asks the Guide to demonstrate the next step of a task, the Guide performs the next step automatically, but does not perform actions that send data or commands to the electronic device. After demonstrating the step, the Guide resets the simulation to the state it was in when the demo began.

As shown in FIG. 14, the Simulation Configuration File 131 contains a description of all of the displayable graphical entities and sound definitions, a list of the active regions and their coordinates, and a definition of the state machines, for the electronic device to which it is associated. The Simulation Configuration File 131 also contains the definition of the directed graph for the Guide, along with textual hints, textual descriptions, active region identifiers, results, and conditions for the arcs of the graph.

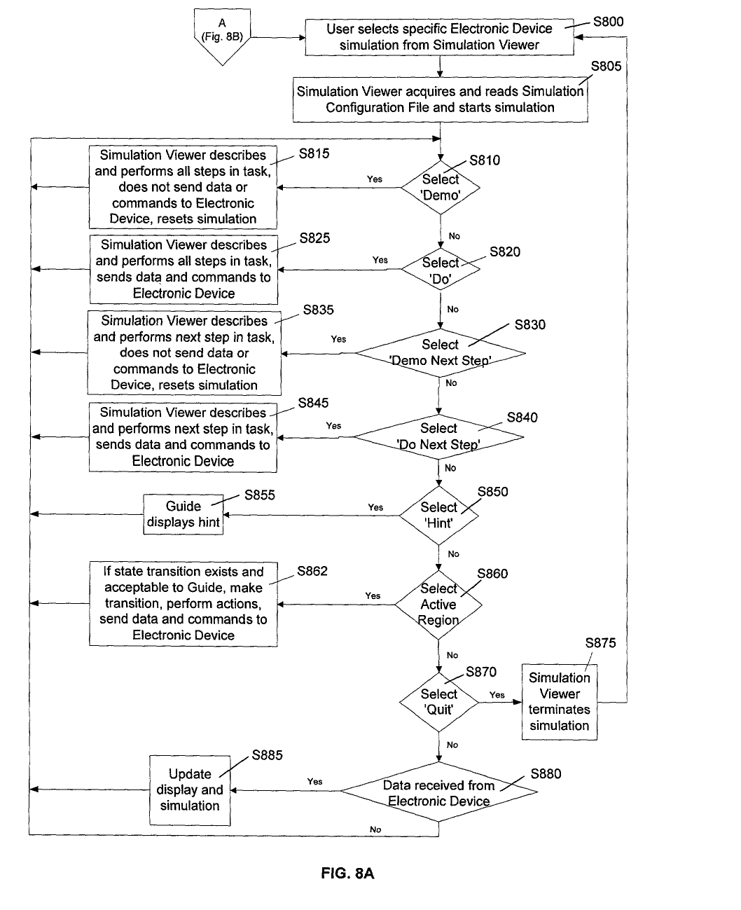

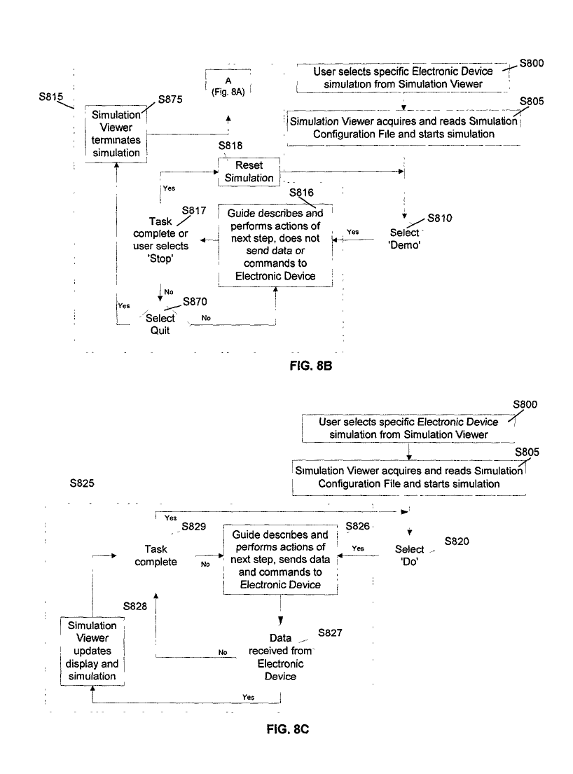

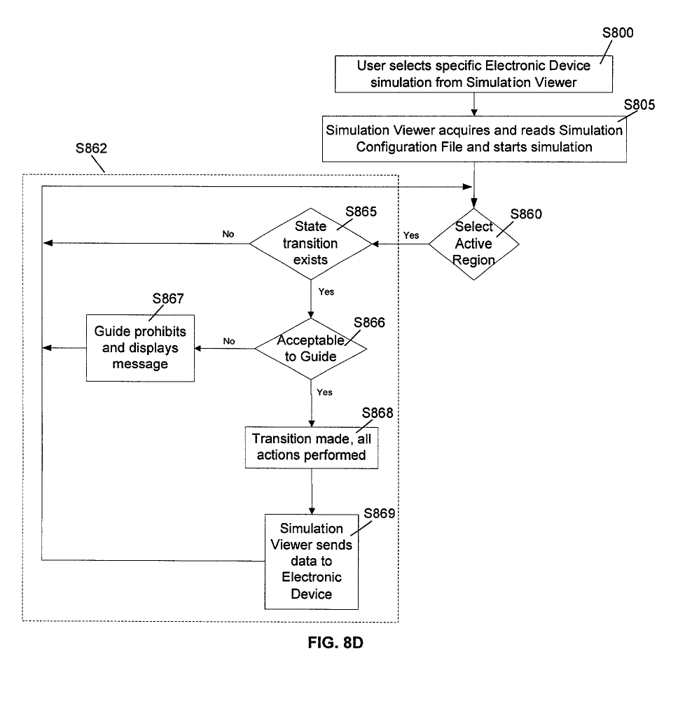

FIG. 8A shows the operation of the Simulation Viewer when the user accesses and interacts with a guided simulation of an electronic device. The user first selects a specific electronic device in the Simulation Viewer S800. FIG. 9 shows how this can be done with a list. The Simulation Viewer acquires the Simulation Configuration File from the Electronic Device if necessary, reads it, and starts the simulation S805. FIG. 10 shows the appearance of the Local Display Device at this point.

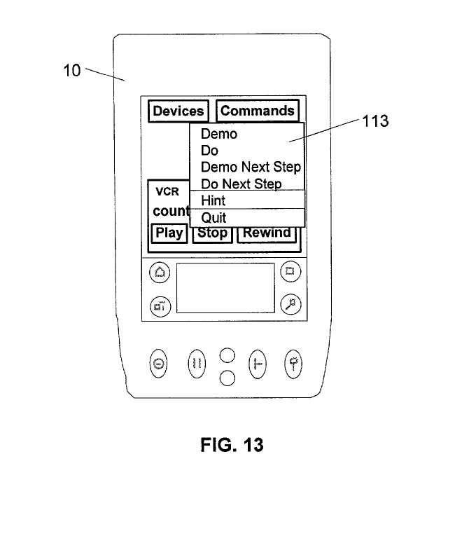

As shown in FIG. 8A, once the simulation has started, the user may select any of several options. These include Demo S810, Do S820, Demo Next Step S830, Do Next Step S840, Hint S850, or Quit S870. FIG. 13 shows an example of these options in a command menu 113. In addition, the user may select any active region S860 within the graphical depiction of the simulated electronic device. At each step of the simulation, the user may preferably select any of these options.

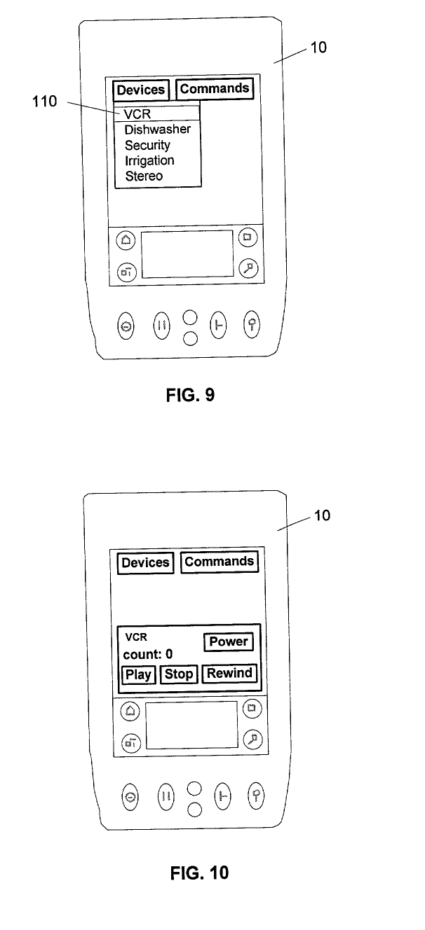

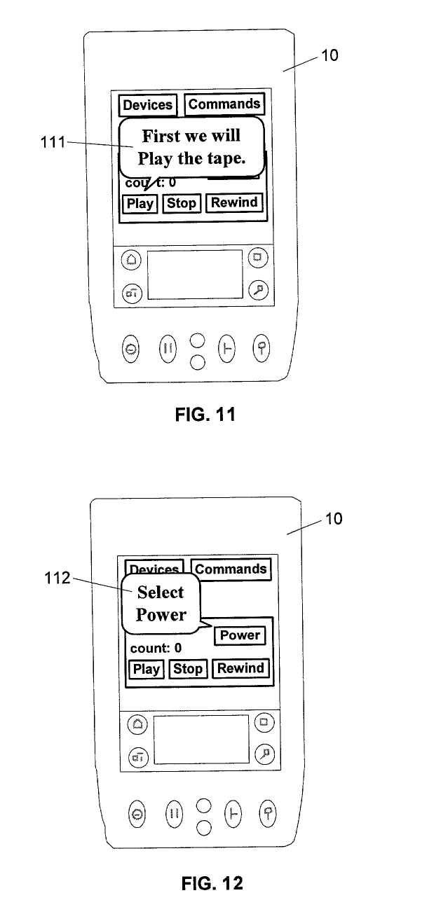

If the user selects the Demo option S810, the Simulation Viewer begins to run the task step by step automatically without sending data or commands to the Electronic Device S815. The details of this procedure are shown in FIG. 8B. At each step, the Guide preferably displays a textual description of the step, which may optionally be heard audibly as it is spoken by a text-to-speech engine. The textual description is preferably contained in a text bubble, which points to a specific active region on the graphical depiction as shown in FIGS. 11-12. The Guide then selects the active region that the text bubble is pointing to, which performs the actions of the next step S816 as if the user had selected the active region (without sending any parameters and commands). FIG. 11 shows the appearance of the Simulation Viewer with a description text bubble 111. The graphical depiction of the item changes much as the real item would change appearance. After each step, if the task is complete or the user selects ‘Stop’ S817, the Simulation Viewer resets the simulation to the state it was in before the demo began S818. If the user selects ‘Quit’ S870, the Simulation Viewer terminates the simulation S875. Until the task is complete or the user selects either Stop S817 or Quit S870, the task will continue to run step by step automatically.

If the user selects the Do option S820 as shown in FIG. 8A, the Simulation Viewer begins to run the task step by step automatically, sending data and commands to the electronic device S825. The details of this procedure are shown in FIG. 8C. As in the Demo option, the Guide displays a textual description of the step, which can also be heard audibly as it is spoken by a text-to-speech engine, and performs the actions of the next step S826. The Guide also sends data and commands to the Electronic Device. If the Simulation Viewer receives data from the Electronic Device S827, it updates the display and simulation S828. Until the task is complete S829, the task will continue to be performed automatically step by step. Preferably, the user cannot select Stop or Quit while the Simulation Viewer is doing the task.

If the user selects the Demo Next Step option S830 as shown in FIG. 8A, the Simulation Viewer performs the next step in the task, displaying and preferably speaking a description of the step, but does not send data or commands to the electronic device S835. Once the step of the task is complete, the Simulation Viewer resets the simulation to the state it was in before the step was performed.

If the user selects the Do Next Step option S840, the Simulation Viewer performs the next step in the task, displaying and speaking a description of the step, and sends data and commands to the electronic device S845.

If the user selects the Hint option S850, the Guide displays a textual hint for the next step, which can also be heard audibly as it is spoken by a text-to-speech engine S855. The textual description is contained in a text bubble, which may or may not point to an active region on the graphical depiction. FIG. 12 shows the appearance of the Simulation Viewer with a Hint text bubble 112.

If the user selects an active region S860, the Simulation Viewer performs a step in the simulation if it is allowed S862. The details of an example of this procedure are shown in FIG. 8D. The Simulation Viewer first checks that the event causes a transition from the current state to another state in the state machine S865. If it does not, nothing happens. If the event does cause a transition, the Simulation Viewer then checks that the transition is acceptable to the Guide S866. If it is not acceptable to the Guide, the Guide will display an advisory textual message which can also be heard audibly S867. If it is acceptable, the transition is made and all actions are performed S868. If the actions include sending data (including commands) to the electronic device, the Simulation Viewer does so S869 via the communications device.

In the case of all textual messages (hints, descriptions, and advisories), the preferred embodiment of the Simulation Viewer includes voice generation capability causing an audible message corresponding to each textual message. The present invention does not limit the Guide to use a text bubble pointing the active region nor to generate audible text with a text-to-speech engine, as other means to display text, indicate the active region, and generate speech may be used. Additionally, the Guide may only display text with no speech, or may only generate speech with no text.

If the user selects the Quit option S870 as shown in FIGS. 8A-B, the Simulation terminates S875 and the Simulation Viewer returns to a mode where the user is able to select a specific electronic device simulation S800. If data is received from the Electronic Device S880, the Simulation Viewer updates the display and the simulation as appropriate S885.

Unless contrary to physical possibility, the inventor envisions the methods and systems described herein: (i) may be performed in any sequence and/or combination; and (ii) the components of respective embodiments combined in any manner.

It should be recognized that only examples of specific embodiments of the present invention have been described above. Accordingly, although there have been described preferred embodiments of this novel invention, many variations and modifications are possible and the embodiments described herein are not limited by the specific disclosure above, but rather should be limited only by the scope of the appended claims.

What is claimed is:

1. An apparatus capable of controlling multiple electronic devices comprising:
a local display device comprising a simulation viewer operative to remotely simulate a selected electronic device based on a simulation configuration file, the local display device operative to enable control of at least one function of the selected electronic device remotely.

2. The apparatus according to claim 1, wherein the simulation viewer comprises a simulator for providing a graphical depiction of a control for the at least one function of the selected electronic device.

3. The apparatus according to claim 2, wherein the simulation viewer further comprises a guide for providing assistance to a user in controlling the selected electronic device.

4. The apparatus according to claim 1, wherein the simulation configuration file includes information specific to the selected electronic device and is communicated to the local display device over a communications network upon a user selecting the selected electronic device.

5. The apparatus according to claim 4, wherein the information specific to the selected electronic device includes at least one of: (1) information for graphical representation of a control for the at least one function of the selected electronic device for simulation on the local display device, (2) a logic expression for controlling the at least one function of the selected electronic device by the local display device, (3) sound definitions for simulating sounds of the selected electronic device, and (4) information for assisting a user in controlling the at least one function of the selected electronic device.

6. The apparatus according to claim 5, wherein the logic expression for controlling the at least one function of the selected electronic device is a definition of a state machine.

7. The apparatus according to claim 1, wherein the local display device is a general purpose device selected from the group consisting of, a personal digital assistant, a cellular phone or a computer.

8. The apparatus according to claim 4, wherein the communications network is wireless network and uses a Bluetooth communications protocol.

9. The apparatus according to claim 8, wherein the selected electronic device comprises one of the following, a VCR, a stereo system, a security system, a climate control system, an irrigation control system, a television, a digital video disk player, a car radio, a home appliance, automotive electronics, medical instruments, communications equipment, and industrial machinery.

10. The apparatus according to claim 3, wherein the guide provides assistance to the user of the local display device in at least one of a text format and an audio format.

11. A universal control system comprising:
at least one electronic device over which a user desires to exert control, the at least one electronic device including a simulation configuration file; and
a local display device configured to remotely control the at least one electronic device over a communications network, the local display device comprising a simulation viewer operative to simulate at least one control of the at least one electronic device on the local display device based on the simulation configuration file.

12. The universal control system according to claim 11, wherein there are a plurality of electronic devices each having respective simulation configuration files.

13. The universal control system according to claim 11, wherein the simulation configuration file is configured to be downloaded via the communications network to the local display device upon selection of the at least one electronic device by a user from the local display device.

14. The universal control system according to claim 11, wherein the communications network is a wireless network using a Bluetooth protocol.

15. The universal control system according to claim 11, wherein the simulation configuration file includes information specific to the at least one electronic device and includes at least one of, (1) information for graphical representation of the at least one control, (2) a logic definition for controlling the at least one control, (3) a sound definition for simulating sound of the at least one control, and (4) information for assisting a user in controlling the at least one control of the at least one electronic device.

16. A method of controlling electronic devices over a communications network with a local display device, the method comprising:
selecting, via the local display device, an electronic device to be controlled;
transferring a simulation configuration file from the selected electronic device to the local display device, via the communications network;
simulating at least one control of the selected electronic device on the local display device based on the transferred simulation configuration file; and
controlling the selected electronic device with the simulated at least one control on the local display device.

17. The method of controlling electronic devices according to claim 16, wherein controlling the selected electronic device includes providing guided assistance to a user of the local display device in controlling the selected electronic device.

18. The method of controlling electronic devices according to claim 17, wherein simulating the at least one control includes displaying graphical representations of the at least one control on the local display device.

19. The method of controlling electronic devices according to claim 16, wherein before selecting the electronic device to be controlled, the method includes displaying, on the local display device, designations of all electronic devices available on the communications network.

20. The method of controlling electronic devices according to claim 19, wherein selecting the electronic device to be controlled comprises, touching, by a user using the local display device, the displayed designation of the electronic device to be controlled.

21. An apparatus for remotely controlling at least one electronic device comprising:
a central processing unit (CPU);
a memory coupled to the CPU;
a simulation viewer program stored in the memory;
a display device coupled to the CPU and operative to display a control simulation of the at least one electronic device generated by the simulation viewer program;
an input device coupled to the CPU for allowing a user to interface with the displayed control simulation; and
a communications device coupled to the CPU and configured to receive and transmit information between the at least one electronic device over a communications network.

22. The apparatus according to claim 21, wherein the simulation viewer program generates the control simulation based on a simulation configuration file provided by the at least one electronic device.

23. The apparatus according to claim 22, wherein the simulation configuration file includes information for simulation of and controlling the at least one electronic device.

24. The apparatus according to claim 23, wherein the simulation viewer program comprises a simulator for generating the control simulation and a guide for providing assistance to a user.

25. The apparatus according to claim 24, wherein the simulation configuration file further includes information for the guide

26. The apparatus according to claim 21, wherein the communications network is a wireless network.

27. The apparatus according to claim 26, wherein the wireless network uses a Bluetooth protocol.

28. The apparatus according to claim 22, wherein the control simulation comprises graphical entities defined by the simulation configuration file.

29. The apparatus according to claim 24, wherein the guide provides assistance to the user in the form of at least one of, predetermined textual messages and predetermined audio messages.

30. A simulation configuration file for enabling universal control of electronic devices via simulation, the simulation configuration file comprising:
a description of displayable graphical entities of a specific electronic device;
a description of sound definitions for the specific electronic device;
a list of active regions and corresponding coordinates for the displayable graphical entities; and
a definition of logic control for the specific electronic device.

31. The simulation configuration file according to claim 30, further comprising:
a definition of a directed graph for a guide of the specific electronic device;
a list of textual hints and textual descriptions associated with the directed graph; and
active region identifiers for arcs of the directed graph.

32. The simulation configuration file according to claim 31, wherein the definition of logic control is a definition of a state machine for the specific electronic device.

33. The universal control system according to claim 12, wherein the simulation viewer of the local display device is operative to simulate controls of at least two of the plurality of electronic devices at the same time.

34. The universal control system according to claim 1, wherein the simulation viewer of the local display device is operative to simulate more than one selected electronic device at the same time.
